(19) United States
(12) Patent Application Publication
(10) Pub. No.: US 2025/0237241 A1
(43) Pub. Date: Jul. 24, 2025

(54) PISTON-CYLINDER UNIT, SET COMPRISING A PISTON-CYLINDER UNIT AND A GROUP OF PISTON-CYLINDER UNITS

(71) Applicant: PACOMA GMBH, Eschwege (DE)

(72) Inventors: Günter LEICHT, Stegaurach (DE); Karl-Wilhelm HERWIG, Witzenhausen (DE)

(21) Appl. No.: 18/848,093

(22) PCT Filed: Mar. 16, 2023
(86) PCT No.: PCT/EP2023/056768

§ 371 Date: Sep. 17, 2024

(30) Foreign Application Priority Data
Mar. 17, 2022 (EP) 22162786.2

(51) Int. Cl. F15B 15/14; F15B 19/00

(52) U.S. Cl. CPC F15B 15/1447; F15B 15/1428; F15B 19/005

(57) ABSTRACT

The invention relates to a piston-cylinder unit. The piston-cylinder unit has a piston motion sensor which is arranged in a transverse hole of a cylinder head having a longitudinal axis. According to the invention, the piston motion sensor is detachably connected to a housing plug through a sensor cable. The housing plug is L-shaped. One leg of the housing plug extends in the transverse hole of the cylinder head, while another leg extends lying externally from the cylinder head. The invention enables the operation of the piston-cylinder unit with housing plugs of different types.

The piston-cylinder unit according to the invention finds, for example, use for a work machine, construction machine, agricultural machine, maritime machine, wheel loader, excavator, dumper, crane, forklift or lifting platform.

### TECHNICAL FIELD OF THE INVENTION

The present invention relates to a piston-cylinder unit. The piston-cylinder unit can be used in a work machine (in particular a construction machine, an agricultural machine, a maritime machine, a wheel loader, an excavator, a dumper, a crane, a forklift, a lifting platform or another work machine that is used in a known manner in mechanical engineering). The piston-cylinder unit can be used, for example, to steer, support, extend, tilt, raise, lower or otherwise move a part of the work machine (in particular a tool, a rocker arm or another part of the work machine). It is preferably a hydraulic piston-cylinder unit.

Furthermore, the invention relates to a set comprising a piston-cylinder unit, wherein this set can also be used for a work machine.

Finally, the invention relates to a group of piston-cylinder units, the group having different sub-groups and the piston-cylinder units of the different sub-groups being designed and intended for different purposes of use. Such a group of piston-cylinder units may, for example, be manufactured, offered and distributed by a manufacturer for the different purposes of use, or offered and distributed by a distribution company, or stored and/or used by a customer for the different purposes of use.

### STATE OF THE ART

A generic piston-cylinder unit is known from the publication DE 10 2019 122 121 A1. This known piston-cylinder unit is depicted in FIG. 1. In FIG. 1, it is indicated by means of break lines that the piston-cylinder unit 1 can actually be designed longer and only a part of it is depicted. The piston-cylinder unit 1 has a cylinder 2 with a cylinder tube 31, an internal space 3 and a cylinder head 4. The cylinder tube 31 is connected to the cylinder head 4 through a welding seam 23. A bearing bush 5 is arranged in the region of the cylinder head 4. DE 10 2019 122 121 A1 relates to a hydraulic piston-cylinder unit 1, so that the internal space 3 is filled with a hydraulic fluid 29, in particular oil. For this purpose, the cylinder 2 has a connection 6 and a connection 24. A hydraulic circuit (not depicted here) with a hydraulic pump and switching valves is connected to the connections 6, 24. The connections 6, 24 each open into an associated pressure chamber 32, 33. The pressure chambers 32, 33 are formed in the internal space 3 and are separated from one another by a piston 7. The piston 7 is displaceable along the longitudinal central axis 30 of the cylinder 2 while sealing the pressure chambers 32, 33. Depending on the pressure generated at the connections 6, 24 by means of the hydraulic circuit, an actuating force can be generated hydraulically in both directions along the longitudinal central axis 30, which acts on the piston 7, and a change in the volume of the pressure chambers 32, 33 can be brought about with the actuating movement of the piston 7 generated thereby. FIG. 1 shows the position of the piston 7 moved all the way to the right, i.e. the retracted position of the piston-cylinder unit 1. The piston 7 is connected to a piston rod 8, at the externally lying end of which a piston rod eye 9 is arranged. The piston rod eye 9 also has a bearing bush 10. The bearing bushes 5, 10 serve to link the piston-cylinder unit 1 to those parts of the work machine which are to be moved relative to one another by means of the piston-cylinder unit 1 and/or on which the piston-cylinder unit 1 is to exert a force. The piston rod 8 is mounted so as to be translationally movable in the axial direction along the longitudinal central axis 30 by means of a guide bush 11. A rod seal 12, an O-ring 13 and a support ring 14 are provided for mounting and sealing. A further O-ring 15, a scraper 16 and a plain bearing 17 are arranged at the other axial end of the guide bush 11. The piston 7 is arranged in a non-rotatable manner on the piston rod 8 and locked by means of a locking nut 18. Furthermore, an O-ring 19, a piston guide ring 20, a piston seal 21 and a further piston guide ring 22 are arranged on the piston 7. In this way, the piston 7, together with the piston rod 8 and the piston rod eye 9, is mounted in the cylinder tube 31 of the cylinder 2 in a translationally reciprocatingly sealing manner. A sub-chamber 25 of the pressure chamber 33 in the cylinder head 4 adjoins the part of the pressure chamber 33 that is delimited by the cylinder tube 31. The sub-chamber 25 is connected to the connection 24. A sensor signal channel 26 that is extended axially opens into this sub-chamber 25. The sensor signal channel 26 is also part of the pressure chamber 33 and is thus filled with the hydraulic fluid. The sensor signal channel 26 is in turn connected to a transverse hole 27 extending radially to the longitudinal central axis 30 in the cylinder head 4. The transverse hole 27 extends as far as the external surface of the cylinder head 4 and may be connected to the environment by means of a compensating hole (not depicted). A piston motion sensor 28 is arranged in the transverse hole 27. The piston motion sensor 28 serves to detect the axial position of the piston 7 in the cylinder 2 by means of high-frequency technology. For this purpose, the piston motion sensor 28 emits a high-frequency signal, which impinges on the end face of the piston 7 or of the piston rod 8 through the sensor signal channel 26 and through the sub-chamber 25 as well as through the pressure chamber 33 and, after reflection through this front side, returns to the piston motion sensor 28. The movement signal, in particular the distance travelled by the front side, can then be determined from the reflected signal by means of high-frequency technology, in particular by evaluating the runtime. For the exemplary embodiment depicted in FIG. 1, the hydraulic fluid is supplied to the piston motion sensor 28. A sensor housing of the piston motion sensor 28 has seals with which the piston motion sensor 28 is sealed axially on both sides of the sensor signal channel 26 in such a way that the hydraulic fluid cannot escape from the pressure chamber 33 and through the transverse hole 27. The piston motion sensor 28 here has a connecting plug 34 carried by the sensor housing of the piston motion sensor 28 and extending radially outward from the cylinder head 4. With regard to further details, reference is made to document DE 10 2019 122 121 A1, which is the subject matter of the present disclosure.

A further development of this piston-cylinder unit 1 is known from the publication EP 3 957 868 A1. Here, it is proposed that a collimator be arranged in the beam path for the high-frequency signal, which serves to increase the measuring accuracy of the piston motion sensor. A collimator is understood thereby to be an optical device for generating a beam path with parallel beams from previously non-parallel beams of divergent sources. In a first radiation direction from a transmitting unit of the piston motion sensor to the front side of the piston or of the piston rod, the collimator converts the non-parallel beams emitted by the piston motion sensor into parallel beams, which are then also reflected in parallel from the front side of the piston or of the piston rod. The reflected high-frequency beams are then refocused by the collimator in the opposite second radiation direction so that they can be received and evaluated by a receiver unit of the piston motion sensor. The collimator can here also act as a type of filter that focuses only or substantially the high-frequency beams onto the piston motion sensor, which previously ran parallel to one another and to the longitudinal axis of the piston. This makes it possible to filter out high-frequency beams that do not originate, or at least do not originate directly, from the end-side piston base surface. Such unwanted beams are due to the fact that in reality the refraction of the collimator is not ideal, the beams are not ideally emitted and received in a punctiform manner and the piston base surface is not ideally flat. The use of the collimator is intended to improve the signal-to-noise ratio. The collimator may have a dielectric lens. It is also possible to use several dielectric lenses or a Fresnel zone plate. The dielectric lens may have here a convexly curved lens surface and/or consist of a dielectric plastic or a dielectric ceramic, polytetrafluoroethylene, polyethylene or polypropylene or comprise this material. The dielectric lens preferably has a dielectric constant (permittivity) that is greater than that of air and greater than that of the hydraulic fluid in the piston-cylinder unit. The permittivity can be, for example, between 20% and 50% greater than that of the hydraulic fluid in the piston-cylinder unit. The permittivity difference and the curvature of the dielectric lens are coordinated here with each other. The dielectric lens may have a planar-convex lens shape. The convex side of the lens may here face the piston. On the other hand, the planar side then faces the piston motion sensor. The collimator may be formed from the sensor housing or be structurally separated from the piston motion sensor itself and the sensor housing. The piston motion sensor can also be designed as a compact built-in cartridge that contains both the sensor and the evaluation electronics. The piston motion sensor is disposed with an orientation in the transverse hole such that the longest dimension of the piston motion sensor extends in the direction of the longitudinal axis of the transverse hole. Beam deflection elements may be arranged away from the sensor signal channel at a base of the sub-chamber in order to avoid falsification of the measurement results. The collimator may be disposed in the sensor signal channel. With regard to further details, reference is made to the publication EP 3 957 868 A1, which is the subject matter of the present disclosure.

### OBJECT OF THE INVENTION

The object of the present invention is to propose a piston-cylinder unit comprising a piston motion sensor integrated in the cylinder head, which, in particular with regard to
the connection options and/or
the variety of components and/or
the assembly and/or disassembly effort and/or
the variability of the operating conditions and the connection conditions to the work machine
is improved.

Furthermore, the object of the invention is that of proposing a set comprising a piston-cylinder unit which suitable for the use of the piston-cylinder unit for different purposes of use.

Finally, the object of the invention is that of proposing a group of piston-cylinder units in which two sub-groups are designed and intended for different purposes of uses, but in which there is nevertheless a small variety of components.

### Solution

The object of the invention is achieved according to the invention with the features of the independent patent claims. Further preferred embodiments according to the invention can be found in the dependent patent claims.

### DESCRIPTION OF THE INVENTION

The invention proposes a piston-cylinder unit having a cylinder with a cylinder head, a piston axially movable in the cylinder, and a piston motion sensor. In this case, the piston motion sensor is arranged in a transverse hole of the cylinder head having a longitudinal axis. In this respect, the piston-cylinder unit can also be designed according to the prior art cited at the outset in the different variants.

The invention is based in particular on the realization that, according to the prior art (cf. also the prior art mentioned at the outset), the piston motion sensor has a housing which extends as far as the lateral surface of the piston-cylinder unit and out therefrom. A plug is retained on the housing of the piston motion sensor in the externally freely accessible end region, which plug extends radially outward with respect to the longitudinal central axis of the cylinder away from the cylinder head. By contrast, according to the invention, the piston motion sensor is connected to a housing plug through a sensor cable.

The sensor unit thus has two sub-units, namely the piston motion sensor and the housing plug, which are flexibly connected to one another through the sensor cable. The connection through the sensor cable makes it possible in a simple manner the adaptation for using the same piston motion sensor and the same housing plug for piston-cylinder units with different dimensions, in that the sensor cable can then be installed in a more or less curved or stretched manner for the different installation situations. On the other hand, under certain circumstances, the sensor housing may be designed less solid or shorter, since the sensor housing does not have to bridge the entire radial region from the actual measuring region to the connecting plug, but a sub-region may be bridged by the sensor cable.

Furthermore, according to the invention, the sensor cable is detachably connected to the piston motion sensor and/or the housing plug. This allows, for example, a separate assembly initially of only the piston motion sensor, then the connection of the sensor cable and finally the assembly of the housing plug, whereby a corresponding separate disassembly can also take place. Furthermore, it is possible that, for example for maintenance purposes or in the event of a defect, only one piston motion sensor or a housing plug needs to be replaced, while the remaining part of the piston motion sensor and the housing plug can then continue to be used. However, the detachable connection to the sensor cable can also make it possible for the same piston motion sensor to be used with different housing plugs in order to allow adaptation to different purposes of use that require different housing plugs.

It is possible for any desired different housing plugs to be used within the scope of the invention. Thus, on the one hand, the housing plugs can have a different shape. It is possible for a first housing plug to be rectilinear, while a second housing plug, which can be used within the scope of the invention, is L-shaped. In this case, the housing plug may have two angled legs. A leg then extends into the inside of the transverse hole of the cylinder head. The sensor cable can then be connected in the region of a front side of this leg. On the other hand, the other leg extends lying externally from the cylinder head. In this case, it is possible for this leg to extend radially to the longitudinal axis of the transverse hole. For an installation situation, the leg is oriented parallel to the longitudinal central axis of the cylinder of the piston-cylinder unit, which is advantageous for some purposes of use. In this case, the front side of the last-mentioned leg can be used to connect a connecting cable. This embodiment is based, in particular, on the realization that a plug which is aligned radially to the longitudinal central axis of the cylinder and is fixed directly to the housing of the piston motion sensor, as is used in accordance with DE 10 2019 122 121 A1 or EP 3 957 868 A1, is disadvantageous since a connecting cable connected to this plug, when used in the machine tool, usually does not develop radially to the longitudinal central axis of the cylinder, but rather, for example, parallel to the longitudinal central axis. This leads to a kinking of the connecting cable immediately adjacent to the plug, which can lead to damage to the connecting cable. According to the prior art, this is remedied in such a case by mounting an adapter plug on the plug, which then forms a plug receptacle into which the connecting cable can be inserted in a direction parallel to the longitudinal central axis of the cylinder. However, the adapter plug represents an undesirable further component, the reliable contact conditions of which must be guaranteed even under the prevailing harsh operating conditions in the working tool. Here, the housing plug, which extends with one leg into the transverse hole, and whose connection to the sensor cable in the internal space of the transverse hole, which is closed off to the outside by the housing plug, provides a reliable remedy.

It is also advantageous if the housing plug is detachably connected to the cylinder head. For a proposal of the invention, the housing plug has a flange for this purpose. The flange can then screwed to the cylinder head, allowing a reliable connection between the housing plug and the cylinder head.

It is even possible for the flange to be screwed to the cylinder head in different alignments of the housing plug about the longitudinal axis of the transverse hole, which allows to take into account the respective installation conditions.

In addition to the use of housing plugs of different shapes in the piston-cylinder unit according to the invention, the housing plugs can alternatively or cumulatively also be equipped with different connecting geometries and pin assignments.
a) It is possible here, for example, for a first type of housing plug to be designed as a so-called DIN plug. For example, it may be an M12 DIN plug, which may be designed with 5 pins. Such DIN plugs are described in the standards DIN 41524 (3- and 5-pin), DIN 45322 (5-pin with 60° spacing), DIN 45326 (8-pin) and DIN 45329 (7-pin) (these standards are replaced by EN 60130-9).

For this first type of housing plug, different sub-types can then again be used, which differ in the assignment of the connecting pins:
aa) for a first sub-type, a first pin is not assigned. A second pin is assigned to the VDC function (voltage supply of the piston motion sensor). A third pin is assigned to the GND function (earth). A fourth pin is assigned to the data bus CAN HI, while a fifth pin is assigned to a data bus CAN LO.
ab) For a second sub-type of the first type, a first pin may not be assigned, a second pin may be assigned to VDC, a third pin may be assigned to GND, a fourth pin may be assigned to a pulse width modulated signal, and a fifth pin may not be assigned.
b) For a second type of housing plug, the housing plug is designed as a so-called German plug, which can be, for example, a German DT 04 plug with four pins.

Different sub-types are also possible for the second type:
ba) For example, a first sub-type of the second type may be equipped with a first pin that ensures the VDC function. The second pin is assigned to the CAN LO function, a third pin is assigned to the GND function and a fourth pin is assigned to the CAN HI function.
bb) On the other hand, for a second sub-type of the second type, a first pin may be assigned to the VDC function, a second pin may be assigned to the GND function, a third pin may be assigned to the PWM function, and a fourth pin may not be assigned.

According to the invention, it is possible for one and the same piston motion sensor to be optionally combined through the detachable sensor cable with housing plugs of different geometries and angled portions of the legs of the housing plug and/or housing plugs of the different types and sub-types mentioned, depending on requirements and purpose of use.

A further embodiment of the invention uses the insight that for the required accuracy of the measurement results of the piston motion sensor arranged in the transverse hole, it is crucial that the piston motion sensor and thus the transmitter and/or receiver unit for the high-frequency radiation (or another sensor signal) are located
both in the predetermined position in the transverse hole describing the axial position of the piston motion sensor along the longitudinal axis of the transverse hole,
and in the predetermined alignment describing the rotational position of the piston motion sensor about the longitudinal axis of the transverse hole and thus the direction of emission of the signal of the piston motion
sensor. For the embodiments known from the prior art, this requires an increased effort, on the one hand, during the manufacture in terms of manufacturing tolerances and, on the other hand, in the assembly of the piston motion sensor in the transverse hole of the cylinder head.

It is also possible for piston motion sensors and in particular sensor housings with different dimensions to be produced in a series of piston-cylinder units with different dimensions (in particular different diameters of the cylinder tube and thus dimensions of the cylinder head) according to the prior art. The reason for this is that the different dimensions of the piston-cylinder units result in different distances of the sensor signal channel in the inside of the cylinder head from the connecting plug on the external surface of the cylinder head, which means different lengths of the sensor housing.

In this field of tension, the invention proposes that a positioning and/or alignment element can be used. The positioning and/or alignment element ensures the correct positioning of the piston motion sensor in the direction of the longitudinal axis of the transverse hole, so that through the positioning it is ensured that the high-frequency signal of the piston motion sensor passes through the sensor signal channel, any collimator and the pressure chamber in the right place and/or strikes the front side of the piston or of the piston rod in the right place. Alternatively or cumulatively, the alignment of the piston motion sensor can also be predefined by means of the positioning and/or alignment element. If the positioning and/or alignment element is used cumulatively for positioning and aligning the piston motion sensor, it can be ensured in a simple and reliable manner that a deviation of the position and alignment of a sent high-frequency signal of the piston motion sensor lies within a predetermined small tolerance range.

The positioning and/or alignment element is arranged in the transverse hole and is supported hereby in the transverse hole in the direction of the longitudinal axis of the transverse hole, namely in the mounting direction. This support can be provided, for example, on a transverse surface, an inclined surface, a step, a taper or an annular collar of the transverse hole. The positioning and/or alignment element thus assumes a defined axial position in the transverse hole, which can already be predefined during the production of the transverse hole, namely during the production of the transverse surface, inclined surface, step, taper or annular collar.

The piston motion sensor is then supported on the positioning and/or alignment element in the direction of the longitudinal axis on the positioning and/or alignment element. Since the positioning and/or alignment element assumes a defined axial position in the transverse hole, through the support of the piston motion sensor on the positioning and/or alignment element it can be ensured that the piston motion sensor also assumes a defined position in the transverse hole.

It is advantageous that, if the same piston motion sensor is used for piston-cylinder units of different dimensions, the same piston motion sensor can be used in the different piston-cylinder units, although the predetermined position of the piston motion sensor in the transverse hole can then be adapted by the positioning and/or alignment element having different lengths.

As mentioned above, the support of the positioning and/or alignment element can be ensured by any transverse surface, inclined surface, step, taper or an annular collar, etc., of the transverse hole. For a particularly simple proposal of the invention, the transverse hole may be designed as a blind drilled hole, wherein the positioning and/or alignment element is then supported on a base (in particular the edge region of a conical base) of the blind drilled hole. In this case, the position of the positioning and/or alignment element and thus also of the piston motion sensor can be predefined by the depth of the blind drilled hole.

An alignment of the positioning and/or alignment element about the longitudinal axis of the transverse hole can be predefined. This can be achieved, for example, by a form fit of the cross-sections of the housing of the positioning and/or alignment element and of the transverse hole. Thus, for example, the transverse hole may have a groove or recess (or a rib or a projection) extending in the direction of the longitudinal axis, which groove or recess cooperates in a form fitting manner with a rib or a projection (or a groove or recess) of the housing of the positioning and/or alignment element. However, it is also possible that the alignment of the positioning and/or alignment element is ensured by the fact that a front side of the housing of the positioning and/or alignment element facing the base of the transverse hole has an eccentric recess (or a projection) that engages in a corresponding projection (or a recess) of the base.

Another aspect of the invention is dedicated to locking the positioning and/or alignment element within the transverse hole. It is proposed that at least one locking element is present. The locking element is used to lock the longitudinal position of the positioning and/or alignment element in the transverse hole. Thus, the locking element serves to ensure that both the positioning and/or alignment element and the piston motion sensor are in their predetermined position and also remain in operation. Alternatively or cumulatively, it is possible that a locking of the alignment of the positioning and/or alignment element about the longitudinal axis of the transverse hole (and thus possibly also a locking of the alignment of the piston motion sensor) takes place by means of the at least one locking element.

There are many possibilities for the type of conformation of the locking element. For example, a locking bolt, a locking cotter pin, a latching connection, a tongue-and-groove connection for locking an alignment, etc., can be used. For a very simple embodiment, the locking element is a screw. The screw can extend parallel to the longitudinal axis of the transverse hole. For example, it is possible for the screw to extend through a hole from the other side through the base of the blind drilled hole. However, it is also possible for a screw forming the locking element to extend radially to a longitudinal axis of the transverse hole. In any case, the screw is accessible from the outside on the cylinder head and extends through a hole as far as the positioning and/or alignment element, where the screw is then screwed to an internal thread of the positioning and/or alignment element. It is also possible for the positioning and/or alignment element to have both a threaded hole on the front side, which is used when the screw extends parallel to the longitudinal axis of the transverse hole, and a radially oriented threaded hole for mounting in the event that the screw extends radially to the longitudinal axis of the transverse hole.

The positioning and/or alignment element and the piston motion sensor preferably directly abut one another through contact surfaces. These contact surfaces can ensure the correct positioning of the piston motion sensor in the direction of the longitudinal axis of the transverse hole.

It is possible that not only the axial position of the piston motion sensor in the transverse hole needs to be predefined. Rather, it may also be necessary to predefine an alignment of the piston motion sensor with regard to its angle of rotation about the longitudinal axis of the transverse hole. It may be necessary to predefine for example the angle of rotation, so that a sensor signal emitted by the piston motion sensor can pass through a sensor signal channel and/or strike an end face of the piston or of the piston rod at a defined point and/or under a defined alignment. This alignment can be predefined, for example, in that the piston motion sensor interacts with the transverse hole in a form-fitting manner in the circumferential direction, so that, on the one hand, the alignment is predefined through a form fit and, on the other hand, as a result, such a predefined alignment is also maintained during operation. For example, the transverse hole may have a groove or a recess developing in the direction of the longitudinal axis, in which groove or recess a projection or a rib of the housing of the piston motion sensor is then arranged. Conversely, it is possible for the transverse hole to have a rib developing in the direction of the longitudinal axis or a projection that engages in a groove or recess of the housing of the piston motion sensor. It is also possible for the transverse hole, on the one hand, and the housing of the piston motion sensor, on the other hand, to have corresponding non-circular, for example elliptical, cross sections, which ensure an insertion with precise fit in the appropriate alignment.

For a proposal of the invention, the contact surfaces of the positioning and/or alignment element, on the one hand, and of the piston motion sensor, on the other hand, are connected to one another through a form fit in the circumferential direction about the longitudinal axis of the transverse hole. This form fit then restricts or even predefines the possible relative alignments of the piston motion sensor on the one hand and the positioning and/or alignment element (hereinafter contact elements) on the other hand. There are many possibilities for this form fit. To name just a few examples not limiting the invention, one of the two contact elements may have a projection that engages in a slot of the other contact element. It is also possible for one end face of a contact element to have a step that interacts in a form-fitting manner with a corresponding step of the other contact element to ensure that it is prevented from rotating and to predefine the alignment.

A further aspect of the invention is dedicated to enabling disassembly of the piston motion sensor, which can take place, for example, for maintenance purposes, in the event of a defect in the piston motion sensor, for cleaning purposes or for use of another piston motion sensor with a different measuring range or a different measuring accuracy. In this case, it is advantageous if the piston motion sensor is detachably retained on the positioning and/or alignment element, but the connection still ensures a certain retention force. It is advantageous here if only a disassembly force has to be applied for disassembly that exceeds a threshold value of the retention force of the connection.

For one embodiment of the invention, the piston motion sensor is connected to the positioning and/or alignment element through a latching connection. In this case, the latching force of the latching connection predefines the threshold value for the retention force—if the installer applies a disassembly force to the piston motion sensor that is greater than the latching force, the latching connection can be released and the piston motion sensor can be disassembled from the positioning and/or alignment element and removed from the transverse hole.

For another embodiment, a permanent magnet is used that generates a magnetic retention force between the piston motion sensor and the positioning and/or alignment element. For disassembly, the threshold value for the retention force is predefined in this case by the magnetic force. Within the scope of the invention, it is also possible for the piston motion sensor and the positioning and/or alignment element to each have a permanent magnet, between which the magnetic force is then generated.

For disassembly, the installer can apply the required disassembly force in any way. For a proposal of the invention, the piston motion sensor has a disassembly attachment in the region of a front side on the side facing away from the positioning and/or alignment element. The disassembly attachment can be coupled to a disassembly tool. In this case, the necessary disassembly force can be applied to the piston motion sensor through the disassembly tool and the disassembly attachment. For example, the disassembly attachment can be designed as a type of hook connection into which a counter-hooking disassembly tool is hooked, the disassembly attachment and the disassembly tool can form a latching connection, or the disassembly attachment and the disassembly tool can be connected to one another through a permanent magnet. For a particular proposal of the invention, the disassembly attachment is an internal thread of the piston motion sensor. A disassembly rod can then be screwed into this internal thread, so that the necessary disassembly forces can then be applied to the piston motion sensor through the disassembly rod protruding from the transverse hole after screwing in.

In this case, the internal thread can be formed from a solid material of the sensor housing. For a proposal of the invention, the internal thread is formed by a threaded insert. This threaded insert can then be injected into a sensor housing of the piston motion sensor or pressed into a hole of the sensor housing. The use of such a threaded insert is advantageous, for example, if the sensor housing is made of a material in which the production of an internal thread does not provide the required strength. In this case, a stronger material, in particular metal, can be selected for the material of the threaded insert. The stronger material can then provide the required strength for the threaded connection in the region of the thread. On the other hand, the threaded insert can have an enlarged external surface, which then enables a connection over a large area and force transmission to the sensor housing.

For the embodiments known from the prior art, the piston motion sensor was hydraulically connected to the pressure chamber through the sensor signal channel, so that the hydraulic fluid was supplied to the piston motion sensor itself. This required the sensor housing of the piston motion sensor to be equipped with annular grooves on both sides of the sensor signal channel to seal the piston motion sensor in the transverse hole. If a replacement of the piston motion sensor is required for these embodiments, the hydraulic fluid must be drained, otherwise the hydraulic fluid for the disassembled piston motion sensor would escape from the transverse hole. For one embodiment of the piston-cylinder unit, the invention proposes that the transverse hole is hydraulically separated from the pressure chamber through a sealing element. In this case, the piston motion sensor can be disassembled from the transverse hole without it being possible for the hydraulic fluid to cross the transverse hole, since the crossing through the sealing element is blocked. In this case, the sealing element is preferably designed and the material thereof is selected such that it allows the high-frequency radiation of the piston motion sensor to pass through and, if possible, does not impair it in an undesirable manner.

For a particular proposal of the invention, the sealing element is designed as a collimator, so that in this case the collimator is multifunctional, since it ensures the desired beam bundling and parallel alignment and additionally acts as a sealing element. In this case, it is possible for the collimator to have at least one annular groove in the region of its external surface, into which groove a sealing ring, in particular an O-ring, is inserted, which sealingly interacts with the sensor signal channel in which the collimator is arranged.

A further solution to the object underpinning the invention is a set which has a piston-cylinder unit, as has been explained above. There are at least two housing plugs in the set. These two housing plugs are designed and intended for different purposes of use. Thus, for example, the two different housing plugs can be housing plugs of the previously explained different geometries, types and/or sub-types. The two housing plugs can then be selectively inserted into the transverse hole, and the selected housing plug can be fixed to the housing of the piston-cylinder unit. In this case, the housing plug that has been respectively selected is then connected to the piston motion sensor by means of the sensor cable. In this way, a set can be provided for the customer, with which the same piston motion sensor can be connected to different housing plugs in different installation situations, whereby the variety of applications can be expanded and the variety of components can be reduced.

A further solution to the object underpinning the invention is represented by a group of piston-cylinder units, as have been explained above. In this case, the group has two different sub-groups of piston-cylinder units, wherein both of these sub-groups are then designed and intended for different purposes of use. In the first sub-group, the piston-cylinder units have first housing plugs, while in the second sub-group, the piston-cylinder units have the second housing plugs. The first housing plugs and the second housing plugs are designed and intended for different purposes of use, which means that the piston-cylinder units of the two sub-groups are also designed and intended for different purposes of use. The first housing plugs and second housing plugs may differ from one another, for example, in the different geometries, types and/or sub-types explained above. In the piston-cylinder units of the first sub-group and of the piston-cylinder units of the second sub-group, identical piston motion sensors are then present. For example, such a group with the different sub-groups can be offered by a manufacturer or a sales company, so that the customer can then purchase the piston-cylinder units of the first sub-group or the second sub-group depending on the desired purpose of use. However, it is also possible for such a group of piston-cylinder units to be kept ready for the different purposes of use at an end customer, in a repair shop or a manufacturer of a work machine.

Advantageous further developments of the invention are shown in the patent claims, the description and the drawings.

The advantages of features and of combinations of several features mentioned in the description are merely exemplary and can take effect in an alternative or cumulative manner, without the advantages necessarily having to be achieved by embodiments according to the invention.

With regard to the disclosure content—not the scope of protection—of the original application documents and the patent, the following applies: further features can be found in the drawings, in particular in the geometries depicted and in the relative dimensions of several components in relation to each other as well as their relative arrangement and operative connection. The combination of features of different embodiments of the invention or of features of different patent claims is also possible, in deviation of the selected back references of the patent claims, and is hereby suggested. This also applies to those features that are depicted in separate drawings or are mentioned in their description. These features can also be combined with features of different patent claims. Similarly, features listed in the patent claims may be omitted for further embodiments of the invention, but this does not apply to the independent patent claims of the granted patent.

The features mentioned in the patent claims and in the description are to be understood with regard to their number in such a way that exactly this number or a number greater than the number mentioned is present, without the explicit use of the adverb “at least” being necessary. Thus, if, for example, an element is mentioned, this is to be understood as meaning that exactly one element, two elements or more elements are present. The features cited in the patent claims can be supplemented by further features or can be the only features that the subject matter of the respective patent claim has.

The reference numerals contained in the claims do not limit the scope of the subject matter protected by the claims. They merely serve the purpose of making the patent claims easier to understand.

### BRIEF DESCRIPTION OF THE FIGURES

The invention is explained and described in more detail below on the basis of preferred exemplary embodiments illustrated in the figures.

FIG. 1 shows a piston-cylinder unit according to the prior art in a longitudinal section.

FIG. 2 shows a partial longitudinal section of a piston-cylinder unit in the region of the cylinder head.

FIG. 3 shows a three-dimensional exploded view of the cylinder head according to FIG. 2 with associated components.

FIG. 4 shows a three-dimensional view of a piston motion sensor and a positioning and/or alignment element.

FIG. 5 shows a spatial view of a housing plug of the DIN plug type (5-pin) with sensor cable.

FIG. 6 shows the housing plug with sensor cable according to FIG. 5 in a side view.

FIG. 7 shows a spatial view of a housing plug of the German plug type (4-pin) with sensor cable.

FIG. 8 shows the housing plug according to FIG. 7 in a side view.

### DESCRIPTION OF THE FIGURES

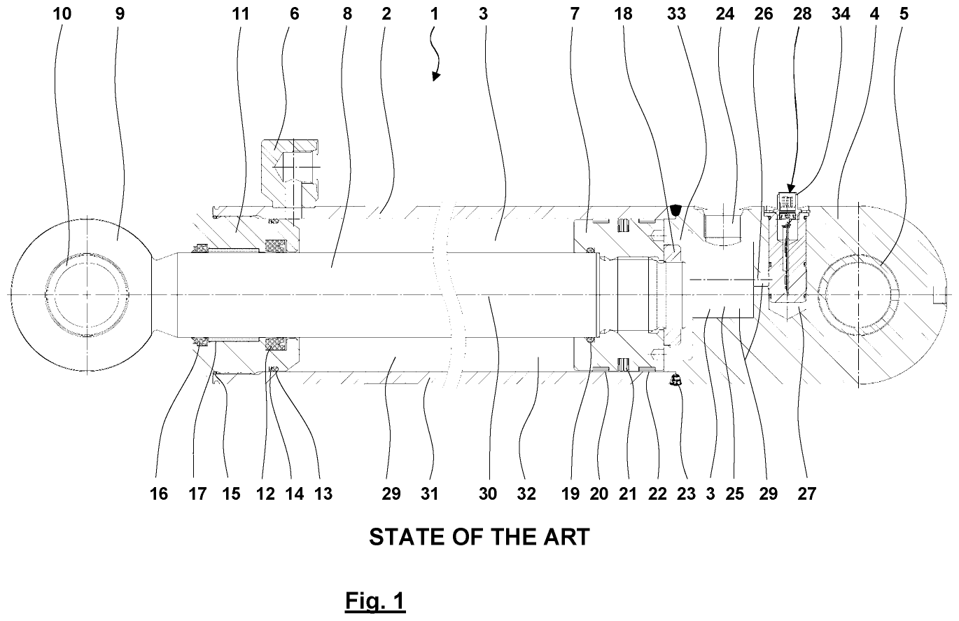

Unless otherwise stated below, the statements made at the outset with regard to the prior art and the embodiment according to FIG. 1 may apply accordingly to the embodiments according to the invention, it also being possible to use the further disclosure in the publications DE 10 2019 122 121 A1 and EP 3 957 868 A1 within the scope of the invention.

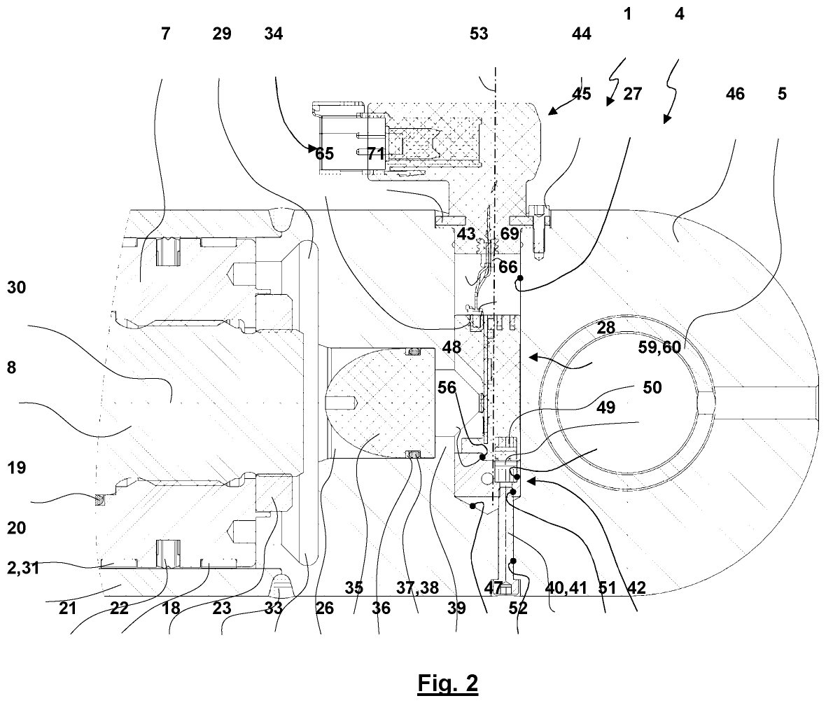

FIG. 2 shows a piston-cylinder unit 1 in the region of the cylinder head 4. A sensor signal channel 26 opens into the pressure chamber 33 of the piston-cylinder unit 1. A collimator 35 is arranged in the sensor signal channel 26. On the side facing the piston motion sensor 28, the collimator 35 has a planar front side that is oriented transversely to the longitudinal central axis 30. With respect to the longitudinal central axis 30, the collimator 35 is designed rotationally symmetrical on the other side, wherein the collimator 35 can have a curved and in particular parabolic longitudinal section, for example, as depicted. The collimator 35 has an annular groove 36 in which a sealing element 37, in this case an O-ring 38, is arranged. The sealing element 37 ensures a hydraulic seal between the internal wall of the sensor signal channel 26 and the collimator 35. The sensor signal channel 26 has a circumferential shoulder 39 here. If a hydraulic pressure is applied to the pressure chamber 33, the hydraulic pressure acting on the spherical front side facing the piston 7 leads to a hydraulic force that presses the collimator 35 against the shoulder 39. As a result of this pressing of the collimator 35 on the shoulder 39 and/or the action of the sealing element 37, it can be ensured that no hydraulic fluid is supplied to the transverse hole 27 and therefore no additional sealing measures have to be taken in the transverse hole 27. On the other hand, this seal makes it possible to disassemble the piston motion sensor 28 without hydraulic fluid being able to escape from the transverse hole 27.

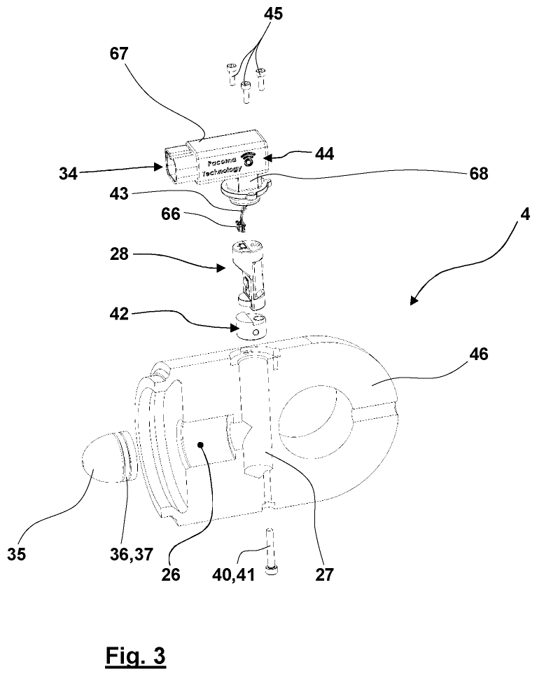

As can be seen from the exploded view in FIG. 3, a locking element 40 in the form of a screw 41, a positioning and/or alignment element 42, the piston motion sensor 28, a sensor cable 43 and a housing plug 44 are mounted in the transverse hole, the housing plug 44 being fixed to a housing 46 of the cylinder head 4 through fixing screws 45.

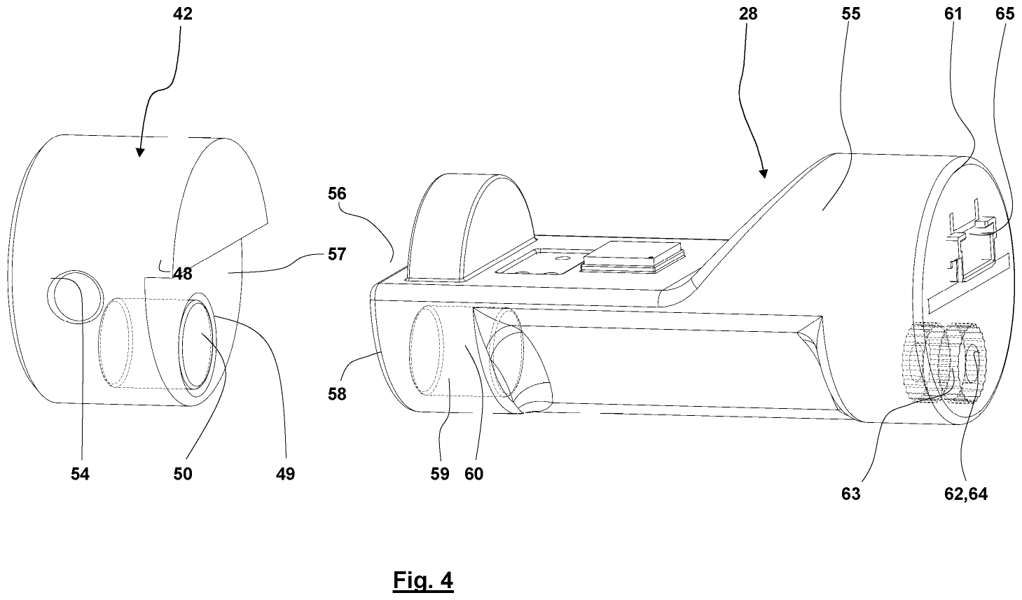

According to FIG. 4, the positioning and/or alignment element 42 is cylindrical with a diameter such that the positioning and/or alignment element 42 can be inserted into the transverse hole 27 with a precise fit. The underside of the positioning and/or alignment element 42 is flat for the exemplary embodiment depicted. The underside of the positioning and/or alignment element 42 abuts on a base 47 of the transverse hole 27, which is designed here as a blind drilled hole.

On the side facing the piston motion sensor 28, the positioning and/or alignment element 42 is basically planar, but is formed with a step 48. On this side, the positioning and/or alignment element 42 has a (here cylindrical) receptacle 49, in which a permanent magnet 50 is received, which can be bonded to or pressed into the receptacle 49. In this case, the external surface of the permanent magnet 50 is arranged flush with a partial surface of the front side of the positioning and/or alignment element 42 away from the step 48.

On the side facing away from the piston motion sensor 28, the positioning and/or alignment element 42 has an internal thread 51 arranged eccentrically to the longitudinal axis 53 of the transverse hole 27. In the aligned position of the positioning and/or alignment element 42 installed in the transverse hole 27, the internal thread 51 of the positioning and/or alignment element 42 is aligned with an eccentric hole 52 opening into the transverse hole 27, through which the screw 41 extends from the outside through the housing 46. In this way, the positioning and/or alignment member 42 is fixed in the correct position and alignment.

It is possible for the positioning and/or alignment element 42 also to have a transverse hole 54, optionally with an internal thread. If a hole 52 that is oriented parallel to the longitudinal axis 53 of the transverse hole 27 is not present or used as depicted in FIG. 2, but rather a hole that is oriented vertically to the plane of the drawing according to FIG. 2 is provided in the housing 46, as an alternative to fixing through the screw 41, the positioning and/or alignment element 42 can be fixed through a screw that extends vertically to the plane of the drawing according to FIG. 2 through the housing 46 and is screwed in the internally lying end region to the transverse hole 54 of the positioning and/or alignment element 42.

The piston motion sensor 28 has a sensor housing 55, the external geometry of which is cylindrical with a diameter such that the sensor housing 55 can be accommodated with a precise fit in the transverse hole 27. Compared to this external geometry, the sensor housing 55 has cavities in the region of which the electronic module and the transmitting and/or receiving unit for the high-frequency signal are arranged.

On the side facing the positioning and/or alignment element 42, the sensor housing 55 has a step 56, which is designed correspondingly to the step 48 of the positioning and/or alignment element 42. Away from the steps 48, 56, the positioning and/or alignment element 42 and the sensor housing 55 form contact surfaces 57, 58 oriented transversely to the longitudinal axis 53, in the region where these components abut one another in the direction of the longitudinal axis 53, whereby the axial position of the piston motion sensor 28 is predefined.

On the other hand, the steps 48, 56 form a form fit with respect to a rotation about the longitudinal axis 53, whereby the alignment of the piston motion sensor 28 is predefined. In the relative alignment predefined by the steps 48, 56, a corresponding receptacle 59 with a permanent magnet 60 is provided on the sensor housing 55 in alignment with the receptacle 49 and the permanent magnet 50 of the positioning and/or alignment element 42. The permanent magnet 60 is also fixed in the receptacle 59, for example by gluing or pressing. The magnetic force between the permanent magnets 50, 60 locks the abutment and thus the position and alignment between the positioning and/or alignment element 42 and the piston motion sensor 28.

On the side facing away from the positioning and/or alignment element 42, the sensor housing 55 has a planar end face 61. In the region of this end face 61, the piston motion sensor 28 has an internal thread 62, which is formed here by a threaded insert 63 injected into the sensor housing 55. The internal thread 62 forms a disassembly attachment 64.

Furthermore, a plug receptacle 65, into which a plug 66 of the sensor cable 43 can be inserted, is provided in the front side 61. Preferably, the format of the plug 66 and of the plug receptacle 65 is a 5-pin pico-clasp connection (registered trademark).

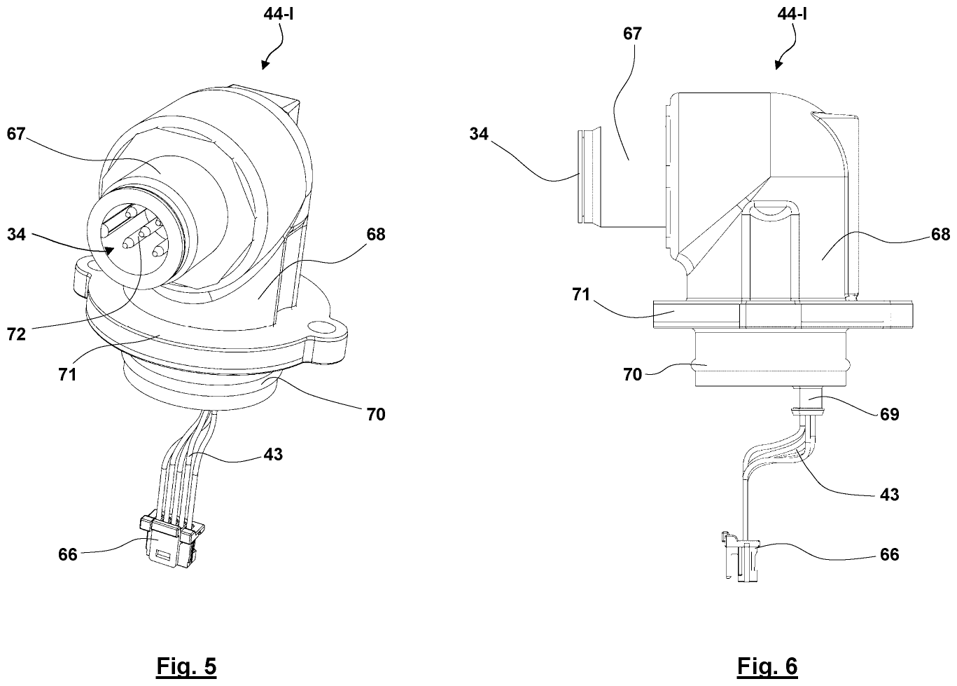

FIGS. 5 and 6 show a housing plug 44-I, wherein “I” here denotes that it is a housing plug of a first type (see the explanations for the first type above).

As can be seen in FIG. 6, the housing plug 44-I is L-shaped with a leg 67 and a leg 68 angled here at an angle of 90°. A plug receptacle into which a plug 69 of the sensor cable 43 can be inserted is provided in the front side of the leg 68. Preferably, both the plug receptacle and the plug 69 have the “pico-clasp” format.

When oriented, the externally lying end region of the leg 68 extends coaxially with the longitudinal axis 53 into the transverse hole 27. The end region of the leg 68 may have a circumferential bead 70 or a sealing element. In the state inserted into the transverse hole 27, the bead 70 generates a frictional, elastically prestressed locking of the leg 68 in the transverse hole 27. In addition, a seal can be made here.

In the exit region of the leg 68 from the housing 46 of the cylinder head 4, the leg 68 has a circumferential flange 71 here. The flange 71 is received in a corresponding receptacle or slot of the housing 46. The flange 71 has through-holes oriented parallel to the longitudinal axis 53, through which the flange 71 can be screwed to corresponding threaded holes of the housing 46. Preferably, a plurality of holes are provided in the flange 71 and threaded holes are provided in the housing 46, so that the housing plug 44-I can be screwed to the housing 46 in different alignments about the longitudinal axis 53.

The end region of the leg 67 forms the connecting plug 34, which allows the connecting cable to be connected.

For the housing plug 44-I, the connecting plug 34 has 5 pins 72, as can be seen in particular in FIG. 5. This is in particular a connecting plug 34 of the type “5-pin M12 DIN plug”. In this case, the housing plug 44-I of the first type can be designed in accordance with the sub-types explained at the outset.

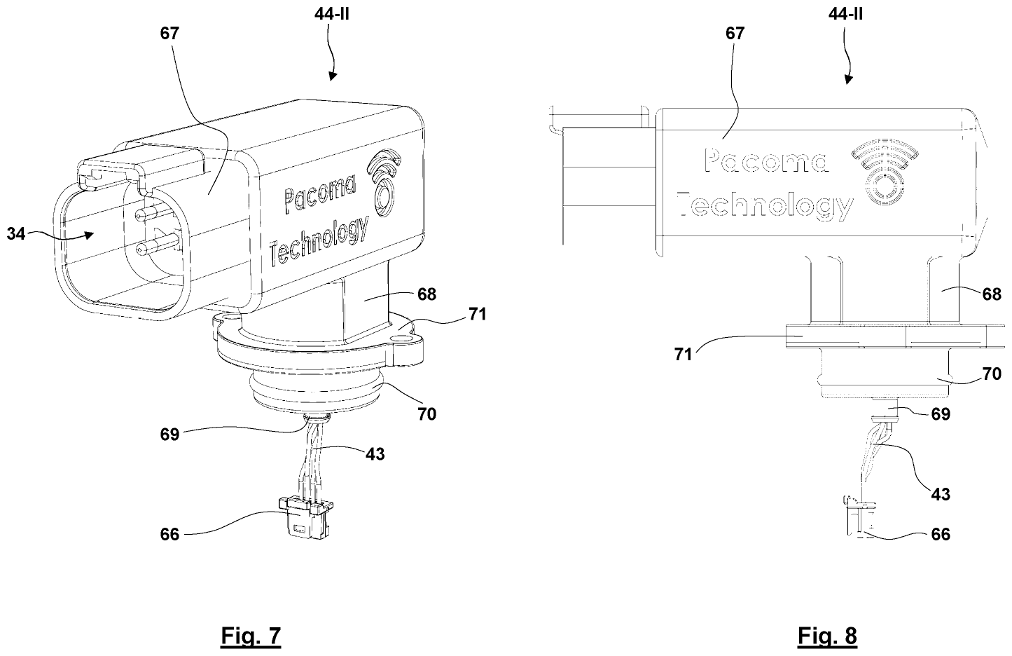

FIGS. 7 and 8 show a housing plug 44-II, wherein here “II” denotes that it is a housing plug of a second type. In this case, the housing plug 44-II of the second type may be designed in accordance with the sub-types explained at the outset.

The electronic components are respectively integrated into the housing plug 44 in order to carry out a modification of the transmitted signals from the plug 69 to the connecting plug 34.

The piston motion sensor 28 is used to directly measure the stroke of the piston 7 or of the piston rod 8 within the piston-cylinder unit 1. The piston motion sensor 28 is preferably based on a non-contact measuring radar system, in which the runtime between a transmitting unit, the end face of the piston 7 or piston rod 8, and the reflected signal back to a receiving unit is evaluated. The position and/or the speed can then be determined with high accuracy and robustness from the runtime.

The piston-cylinder unit 1 is preferably designed with the integrated piston motion sensor 28 in accordance with protection class IP69K.

It is possible that through the piston motion sensor 28 a stroke can be determined which is in the range from 10 mm to 2,000 mm, for example 30 mm to 1,800 mm or 40 mm to 1,600 mm. In this case, for example, a resolution in the range from 0.2 mm to 4 mm, for example 0.5 to 2 mm or 0.8 to 1.5 mm, can be achieved.

Another advantage of sealing the sensor signal channel 26 through a sealing element or a multifunctional collimator 35 is that the high hydraulic pressures, which can also be 100 bar to 600 bar, cannot lead to deformations, stresses, and damage to the piston motion sensor 28, the sensor housing 55, and the electronic components of the piston motion sensor 28.

The pico-clasp plug used for the sensor cable 43 and its connection to the piston motion sensor 28 and the housing plug 44 may have five pins, which may be assigned to GND, VDC, CAN LO, CAN HI and an analog signal.

The analog signal can be used to transmit a pulse width modulated signal (PWM), wherein the measurement signal is transmitted through the pulse width modulation. Alternatively, it is possible for a voltage or a current that is proportional to the measurement signal to be transmitted as an analog signal.

Under certain circumstances, the piston motion sensor 28 does not only measure the stroke and/or the speed of the piston 7 or of the piston rod 8. Alternatively, it is also possible for other measured variables (such as the temperature) to be measured, transmitted and/or evaluated. Temperature can be used for temperature compensation.

It is also possible that a bidirectional transmission is possible through the housing plug 44, as a result of which software updating of the piston motion sensor 28 can also take place and update functions can be executed.

If a PWM signal is transmitted, it preferably has a frequency of 500 Hz. The duty cycle provides information about the measured path of the piston. For example, if the piston is fully retracted, the duty cycle may be 5%, while for the fully extended state of the piston, the duty cycle may be 95%.

### DESCRIPTION OF SYMBOLS

1 Piston-cylinder-unit
2 Cylinder
3 Internal space
4 Cylinder head
5 Bearing bush
6 Connection
7 Piston
8 Piston rod
9 Piston rod eye
10 Bearing bush
11 Guide bush
12 Rod seal
13 O-ring
14 Support ring
15 O-ring
16 Scraper
17 Plain bearing
18 Locking nut
19 O-ring
20 Piston guide ring
21 Piston seal
22 Piston guide ring
23 Welding seam
24 Connection
25 Sub-chamber
26 Sensor signal channel
27 Transverse hole
28 Piston motion sensor
29 Hydraulic fluid
30 Longitudinal central axis of the cylinder
31 Cylinder tube
32 Pressure chamber
33 Pressure chamber
34 Connecting plug
35 Collimator
36 Annular groove
37 Sealing element
38 O-ring
39 Section
40 Locking element
41 Screw
42 Positioning and/or alignment element
43 Sensor cable
44 Housing plug
45 Fixing screws
46 Housing
47 Base
48 Step
49 Receptacle
50 Permanent magnet
51 Internal thread
52 Hole
53 Longitudinal axis
54 Transverse hole
55 Sensor housing
56 Step
57 Contact surface
58 Contact surface
59 Receptacle
60 Permanent magnet
61 End face
62 Internal thread
63 Threaded insert
64 Disassembly attachment
65 Plug receptacle
66 Plug sensor cable
67 Leg
68 Leg
69 Plug sensor cable
70 Bead
71 Flange
72 Pin

1. A piston-cylinder unit comprising:
a) a cylinder having a cylinder head,
b) a piston axially movable in the cylinder and
c) a piston motion sensor,
d) wherein the piston motion sensor is arranged in a transverse hole of the cylinder head having a longitudinal axis, and
wherein:
e) the piston motion sensor is connected to a housing plug through a sensor cable,
f) the sensor cable is detachably connected to the piston motion sensor and/or the housing plug, and
g) the housing plug is L-shaped with two angled legs, wherein
ga) a leg extends in the transverse hole of the cylinder head and
gb) a leg extends lying externally from the cylinder head.

2. The piston-cylinder unit according to claim 1, wherein the housing plug is detachably connected to the cylinder head.

3. The piston-cylinder unit according to claim 2, wherein the housing plug has a flange which is screwed to the cylinder head.

4. The piston-cylinder unit according to claim 3, wherein the flange can be screwed to the cylinder head in different alignments of the housing plug about the longitudinal axis of the transverse hole.

5. The piston-cylinder unit according to claim 1, wherein a housing plug in the form of
a) DIN plug or
b) German plug
can be connected to the sensor cable.

6. The piston-cylinder unit according to claim 1, wherein a positioning and/or alignment element is supported in the transverse hole in the direction of the longitudinal axis of the transverse hole, and the piston motion sensor is supported on the positioning and/or alignment element in the direction of the longitudinal axis.

7. The piston-cylinder unit according to claim 6, wherein the transverse hole is a blind drilled hole and the positioning and/or alignment element is supported on a base of the blind drilled hole.

8. The piston-cylinder unit according to claim 6, wherein
a) a position of the positioning and/or alignment element in the direction of the longitudinal axis of the transverse hole and/or
b) an alignment of the positioning and/or alignment element about the longitudinal axis of the transverse hole
are/is locked by a locking element, wherein the locking element is preferably a screw that extends parallel to the longitudinal axis of the transverse hole or radially to the longitudinal axis of the transverse hole.

9. The piston-cylinder unit according to claim 6, wherein the positioning and/or alignment element and the piston motion sensor abut one another through contact surfaces, which restrict or predefine an alignment of the piston motion sensor relative to the positioning and/or alignment element through a form fit in the circumferential direction about the longitudinal axis of the transverse hole.

10. The piston-cylinder unit according to claim 6, wherein the piston motion sensor is retained on the positioning and/or alignment element through a latching connection or a permanent magnet.

11. The piston-cylinder unit according to claim 6, wherein the piston motion sensor has, on the side facing away from the positioning and/or alignment element, a disassembly attachment which can be coupled to a disassembly tool in order to apply disassembly forces on the piston motion sensor so as to disassemble the piston motion sensor from the positioning and/or alignment element, the disassembly attachment preferably being designed as an internal thread of the piston motion sensor, and in particular the internal thread being designed as a threaded insert which is injected or pressed into a sensor housing of the piston motion sensor.

12. The piston-cylinder unit according to claim 1, wherein the transverse hole is hydraulically separated from a pressure chamber of the piston-cylinder unit through a sealing element.

13. A set comprising:
a) the piston-cylinder unit according to claim 1, and
b) two housing plugs, which
ba) are designed and intended for different purposes of use,
bb) can optionally be inserted into the transverse hole) and
bc) can be connected to the piston motion sensor through a or the sensor cable).

14. A group of piston-cylinder units comprising:
a) a plurality of sub-groups, each sub-qroup of the plurality of sub-groups including the piston-cylinder unit of claim 1 designed and intended for different purposes of use,
a) wherein the plurality of sub-groups has a first sub-group including a first housing plugs,
b) wherein the plurality of sub-groups has a second sub-group including a second housing plugs,
c) wherein the first housing plugs and the second housing plugs are designed and intended for different purposes of use, and
d) wherein the piston-cylinder units of the first sub-group and the piston-cylinder units of the second sub-group have identical piston motion sensors.
